(19) United States
(12) Patent Application Publication
(10) Pub. No.: US 2015/0049036 A1
(43) Pub. Date: Feb. 19, 2015

(54) METHOD FOR CONTROLLING INPUT STATUS AND ELECTRONIC DEVICE SUPPORTING THE SAME

(71) Applicant: Samsung Electronics Co., Ltd., Suwon-si (KR)

(72) Inventors: Kyungtae KIM, Hwaseong-si (KR); Seungnyun KIM, Incheon (KR); Hyejeon JUNG, Seoul (KR); Jaewoong CHUN, Suwon-si (KR)

(21) Appl. No.: 14/461,843

(22) Filed: Aug. 18, 2014

(30) Foreign Application Priority Data
Aug. 16, 2013 (KR) 10-2013-0097127

(51) Int. Cl. G09G 5/00; G06F 3/041

(52) U.S. Cl. CPC G09G 5/003; G06F 3/0416; G09G 2354/00
USPC 345/173; 345/156

(57) ABSTRACT

A method for controlling an input state and an electronic device supporting the same are provided. The method includes receiving a specific event generation, generating a vibration having a predetermined pattern according to the specific event generation, collecting a current vibration feedback signal according to the vibration, comparing the current vibration feedback signal with a reference vibration feedback signal, and controlling to set the input state of at least one input device to an input-disabled state or an input-enabled state according to a device disposition state corresponding to the current vibration feedback signal.

### CROSS-REFERENCE TO RELATED APPLICATION(S)

This application claims the benefit under 35 U.S.C. §119(a) of a Korean patent application filed on Aug. 16, 2013 in the Korean Intellectual Property Office and assigned Serial number 10-2013-0097127, the entire disclosure of which is hereby incorporated by reference.

### TECHNICAL FIELD

The present disclosure relates to a control of an input state in an electronic device. More particularly, the present disclosure relates to setting an input state of the electronic device to one of an input-enabled state and an input-disabled state in accordance with a device disposition state.

### BACKGROUND

Applications can be installed in an electronic device, and thereby the electronic device can support specific functions according to the types of applications installed in the electronic device. The electronic device may include an input unit configured to generate an input signal. Functions of a specific application can be controlled according to the input signal generated through the input unit.

However, an undesired input signal can be generated in an unintended state of a user. For example, an unintended physical force can be applied to the electronic device resulting in the undesired input signal. The electronic device processes the generated input signal regardless of the user's intention, and thus an undesired operation of the electronic device may be generated.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure address at least the above-mentioned problems and/or disadvantages to provide at least the advantages described below. Accordingly, an aspect of the present disclosure is to provide a technology for minimizing the generation of input signals undesired by a user.

In accordance with an aspect of the present disclosure, a method for controlling an input state is provided. The method includes receiving a specific event generation, generating a vibration having a predetermined pattern according to the specific event generation, collecting a current vibration feedback signal according to the vibration, comparing the current vibration feedback signal with a reference vibration feedback signal, and controlling to set the input state of at least one input device to one of an input-disabled state and an input-enabled state according to a device disposition state corresponding to the current vibration feedback signal.

In accordance with another aspect of the present disclosure, an electronic device for controlling an input state is provided. The electronic device includes a vibrator configured to generate a vibration of a predetermined pattern according to generation of a specific event, a control unit configured to collect a current vibration feedback signal corresponding to the vibration, to compare the current vibration feedback signal with a reference vibration feedback signal, and controlling to set the input state of at least one input device to one of an input-disabled state and an input-enabled state according to a device disposition state corresponding to the current vibration feedback signal, and an input device configured to have one of an input-enabled state and an input-disabled state according to the control of the control unit.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiment of the present disclosure will be more apparent from the following description taken in conjunction with the accompanying drawings, in which:

FIG. 1 is a block diagram illustrating a configuration of electronic device according to an embodiment of the present disclosure;

FIG. 2 is a block diagram illustrating modules for controlling an input state according to an embodiment of the present disclosure;

FIG. 3 is a flow chart illustrating a method for controlling an input state according to an embodiment of the present disclosure;

FIG. 4 is a flow chart illustrating a method of state analysis according to an embodiment of the present disclosure;

FIG. 5 is a block diagram illustrating modules for controlling an input state according to an embodiment of the present disclosure; and

FIG. 6 is a flow chart illustrating a method for controlling an input state according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reasons, some components in the accompanying drawings are emphasized, omitted, or schematically illustrated, and the size of each component does not fully reflect the actual size. Therefore, the present disclosure is not limited to the relative sizes and distances illustrated in the accompanying drawings.

An electronic device according to the present disclosure may be a device having a communication function. For example, the electronic device may be one or combinations of various devices such as a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MP3 player, a mobile medical appliance, an electronic bracelet, an electronic necklace, an electronic accessory, a camera, a wearable device, an electronic clock, a wrist watch, a smart white appliance (for example, a refrigerator, an air conditioner, a vacuum cleaner, an artificial intelligence robot, a TV, a Digital Video Disk (DVD) player, audio equipment, a microwave oven, a washing machine, an air cleaner, or an electronic picture frame), medical appliances (for example, a Magnetic Resonance Angiography (MRA), a (Magnetic Resonance Imaging (MRI), a Computed Tomography (CT), and an ultrasonic instrument), a navigation device, a Global Positioning System (GPS) receiver, an Event Data Recorder (EDR), a Flight Data Recorder (FDR), a set-top box, a TV box (for example, Samsung HomeSync™, Apple TV™, or Google TV™), an electronic dictionary, automobile infotainment equipment, electronic equipment for a ship (for example, navigation equipment for ship or a gyrocompass), avionics, security equipment, electronic clothing, an electronic key, a camcorder, a game console, a Head-Mounted Display (HMD), a flat panel display device, an electronic album, furniture/building/structure having a communication function, an electronic board, an electronic signature receiving device, and a projector. It will be apparent to those skilled in the art that the electronic device according to the present disclosure is not limited to the above equipment.

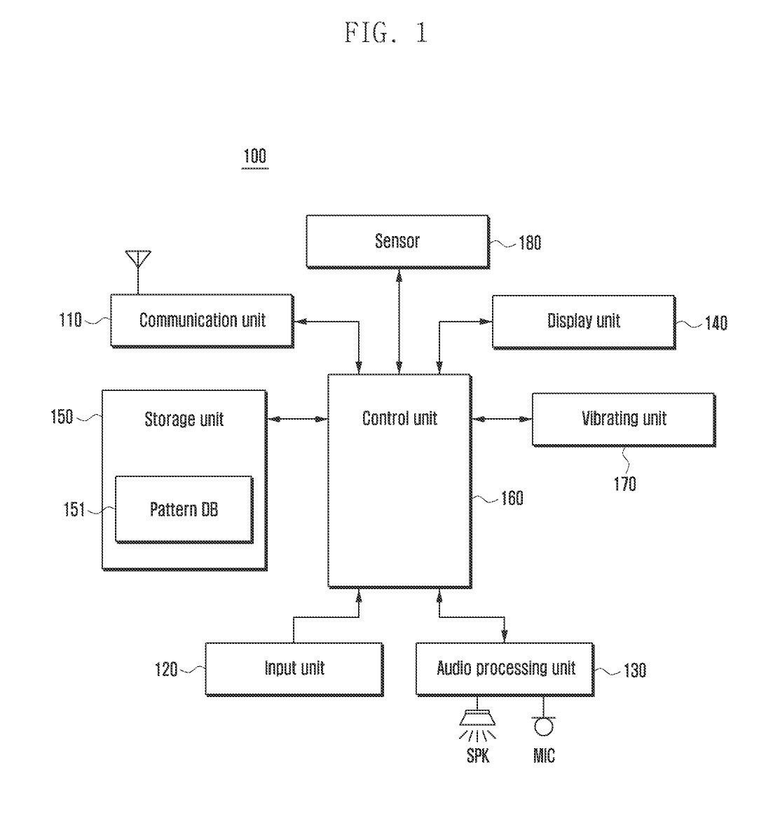

FIG. 1 is a block diagram illustrating a configuration of electronic device according to an embodiment of the present disclosure.

Referring to FIG. 1, the electronic device 100 may include a communication unit 110, an input unit 120, an audio processing unit 130, a display unit 140, a storage unit 150, a vibrating unit 170, and a control unit 160. The electronic device 100 may further include a sensor 180. The input device of the electronic device 100 may include at least one input unit 120, a display unit 140 supporting a touch function, and an audio processing unit 130 supporting a voice control function.

The electronic device 100 controls an input-enabled state of the input device according to a device disposition state. For example, the electronic device 100 identifies a situation in which a user can normally use the input device by using the vibrating unit 170 or both the vibrating unit 170 and the sensor 180. Further, the electronic device 100 can control to switch the input device from an input-disabled state to an input-enabled state according to the identified situation. The electronic device 100 minimizes input malfunctions and supports device operations suitable for a user's intention. According to various embodiments of the present disclosure, the electronic device 100 can control to select the input-enabled state or input-disabled state according to a device disposition state in a specific operation, for example, when a telephone call or a message is received. Further, the electronic device 100 can switch from the input-disabled state to the input-enabled state according to a change of the device disposition state.

The communication unit 110 supports a communication function of the electronic device 100. If the electronic device 100 doesn't support a communication function, the communication unit 110 can be omitted from the configuration of the electronic device 100. If the electronic device 100 is a mobile device, the communication unit 110 can be configured with a mobile communication module (not shown). Further, the communication unit 110 may be configured with a module which can form a local area network channel. The communication unit 110 receives a communication connection request and a message from another electronic device. The communication unit 110 can transmit the received communication request and message to the control unit 160. When the communication unit 110 transmits the communication connection request and the message to the control unit 160, an input-enabled state or input-disabled state of input devices can be decided according to the device disposition state.

The input unit 120 generates signals related to the operation of the electronic device 100. The input unit 120 may include at least one of a key button, a side key, a home key, a menu key, and a power key (not shown). Further, the input unit 120 may include a touchpad (not shown). According to an embodiment of the present disclosure, the input unit 120 can generate an input signal for setting an input state control mode and an input signal for releasing the set input state control mode according to a user's operation. The input unit 120 transmits the generated input signal to the control unit 160. An input signal transmitted by the input unit 120 in the input-enabled state is validated, and an input signal transmitted in the input-disabled state is invalidated.

The audio processing unit 130 processes an audio signal generated in the operation of the electronic device 100. The audio processing unit 130 may include a speaker SPK and a microphone MIC. For example, the speaker SPK of the audio processing unit 130 outputs an audio signal when playing a specific audio file stored in the electronic device 100 and an audio signal received from other electronic devices. The microphone MIC of the audio processing unit 130 collects audio signals to support a recording or communication function of the electronic device 100. According to an embodiment of the present disclosure, the microphone MIC of the audio processing unit 130 can collect a vibration feedback signal having a predetermined pattern generated by the vibrating unit 170. The vibration feedback signal collected by the microphone MIC can be transmitted to the control unit 160.

According to various embodiments of the present disclosure, the audio processing unit 130 outputs a guide or effect sound for setting an input state control mode. The audio processing unit 130 can output the guide or effect sound related to the input-enabled state or the input-disabled state if an input device is required to operate in a state that the input state control mode is set. For example, if a communication connection request or a message is received, the audio processing unit 130 can output the guide or effect sound corresponding to the input-enabled state or the input-disabled state. When the input-disabled state is changed to the input-enabled state, the audio processing unit 130 can output a corresponding guide or effect sound. If an event for input signals is generated by at least one of the input unit 120 and the display unit 140 having an input function in the input-enabled state, the audio processing unit 130 can output a guide or effect sound corresponding to the generated event. If an event for input signals is generated in the input-disabled state, the audio processing unit 130 can omit or restrain from the output of audio signal.

The display unit 140 outputs screens related to the operation of the electronic device 100. For example, the display unit 140 can support a waiting screen, a menu screen, an icon screen, and a specific contents output screen. If the display unit 140 is provided in a touch screen form, the display unit 140 can be used as an input device. The display unit 140 may be configured with a display panel and a touch panel or a touch sheet. The display unit 140 can support a finger touch, an electronic pen touch, or a normal pen touch. The display unit 140 can include a plurality of touch panels or touch sheets.

The display unit 140 can display icons for setting an input state control mode. The display unit 140 can output an indicator in a status bar area corresponding to the setting of the input state control mode. The display unit 140 can provide a screen for distinguishing the input-enabled state and input-disabled state. For example, the display unit 140 can maintain a turn-off state in the input-disabled state, and maintain or switch to a turn-on state in the input-enabled state. According to various embodiments of the present disclosure, the display unit 140 can output at least one of a message, a pop-up, and an indicator which alert the user as to the input-disabled state or input-enabled state in the turn-on state. The display unit 140 can output a screen related to an application (hereafter, “App”) requested to execute in the input-enabled state.

The storage unit 150 stores data and programs related to the operation of the electronic device 100. For example, the storage unit 150 can store an operating system and at least one App. The operating system processes signals for controlling at least one App. The at least one APP may be a program for supporting user functions of the electronic device 100. The at least one App may include a communication App. The communication App can include a telephony App, a message service App, and a data communication App such as a video telephony or a web connection.

According to various embodiments of the present disclosure, the storage unit 150 may include a pattern database (DB) 151. The pattern DB 151 may include information for comparing a vibration feedback signal with a predetermined vibration feedback signal pattern. For example, the pattern DB 151 may include a predetermined vibration feedback signal in a state that the electronic device 100 is disposed in trousers. The pattern DB 151 may include a predetermined vibration feedback signal in a state that the electronic device 100 is disposed in a pocket of shirt or jacket, or in a bag. The pattern DB 151 can include a predetermined vibration feedback signal in a state that the electronic device 100 is handheld by a user. The pattern DB 151 can include a predetermined vibration feedback signal in a state that the electronic device 100 is disposed in an open area. The predetermined vibration feedback signals stored in the pattern DB 151 can be connected with individual state information. The predetermined vibration feedback signal stored in the pattern DB 151 can be compared with a vibration feedback signal collected in a situation that the electronic device 100 is currently disposed. If a stored vibration feedback signal similar to the current vibration feedback signal is detected, the control unit 160 can decide the current state by identifying stored state information corresponding to the detected vibration feedback signal.

The vibrating unit 170 generates a vibration corresponding to a predetermined pattern. The vibrating unit 170 may include at least one vibrator. The vibrating unit 170 can generate vibrations having different patterns according to types of Apps requested to execute or operation states. For example, the vibrating unit 170 may generate vibrations the same or different patterns for a communication connection request and a message reception. In the meantime, the vibrating unit 170 may operate corresponding to the operation of the sensor 180. For example, the electronic device 100 can operate the sensor 180 according to a predetermined period or the generation of a specific event, and detect a speed of an on-coming object or an illuminated state. The electronic device 100 can operate the vibrating unit 170 when the speed or intensity of the illumination is less than or greater than a predetermined value. The vibrating unit 170 then generates a vibration having a predetermined pattern accordingly. According to various embodiments of the present disclosure, the vibrating unit 170 can generate a vibration having a predetermined pattern in a predetermined interval or according to the generation of a specific event independently from the sensor 180.

The sensor 180 generates a signal according to a movement of the electronic device 100 or a macro-environment. The sensor 180 can transmit the generated signal to the control unit 160. For example, the sensor 180 may include a location information collection module, an acceleration sensor, a gyro sensor, a geomagnetic sensor, an altitude sensor, a pressure sensor, a temperature sensor, a humidity sensor, and a software device for receiving inputs from each sensor (all not shown). The sensor 180 may further include at least one of a magnetic sensor, a grip sensor, a proximity sensor, a Red, Green, and Blue (RGB) sensor, a biometric sensor, an illumination sensor, and an ultra violet (UV) sensor (all not shown). The sensor 180 measures physical properties or detects an operating state of the electronic device 100, and converts the detected information to an electric signal. An E-nose sensor, an electromyography (EMG) sensor, an electroencephalogram (EEG) sensor, an electrocardiogram (ECG) sensor, or a fingerprint sensor can be added or substituted to the sensor 180. The sensor 180 may further include a control circuit for controlling at least one sensor integrated therein.

The control unit 160 processes and transmits control signals and data related to the operation of the electronic device 100. According to various embodiments of the present disclosure, the control unit 160 can operate the vibrating unit 170 and identify a disposition state of the electronic device 100 if an event for operating an input device is generated. The control unit 160 decides an input-enabled state or an input-disabled state of the input device according to the disposition state and performs an operation control accordingly. According to various embodiments of the present disclosure, the control unit 160 operates the sensor 180 in advance of operating the vibrating unit 170, and decides the operation of the vibrating unit 170 according to the operation of the sensor 180.

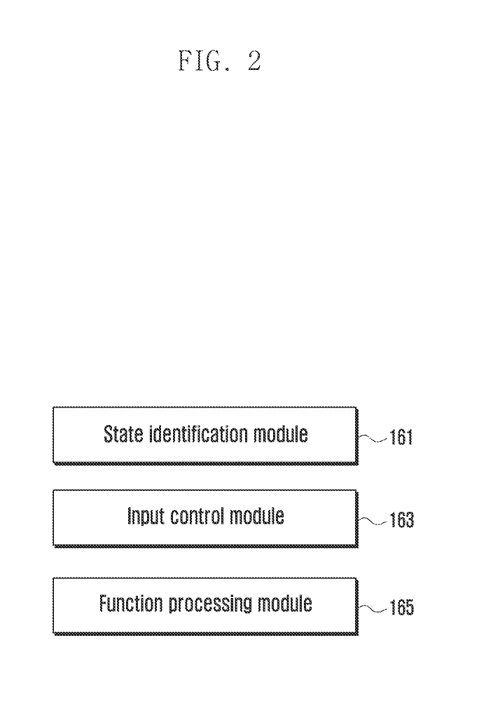

FIG. 2 is a block diagram illustrating modules for controlling an input state according to an embodiment of the present disclosure. The modules for controlling an input state illustrated in FIG. 2 may be included in the configuration of the control unit 160 illustrated in FIG. 1.

Referring to FIG. 2, the modules for controlling an input state may include a state identification module 161, an input control module 163, and a function processing module 165.

The state identification module 161 controls state identification of the electronic device 100. If a specific event related to the operation of the electronic device 100 occurs, the state identification module 161 can control the state identification of the electronic device 100. If an input state control mode is set, the state identification module 161 performs the state identification of the electronic device 100, and if the input state control mode is not set, the state identification module 161 doesn't perform the state identification of the electronic device 100.

The specific event may include an event for receiving a communication connection request, a message reception event, a music play completion event, an alarm event signaling a scheduled appointment, and a download completion event. According to various embodiments of the present disclosure, the specific event may include an event in which a physical force is applied to the input unit 120 corresponding to a button press requesting the generation of an input signal or a touch input event requesting activation of an input device.

According to various embodiments of the present disclosure, the state identification module 161 can perform state identification of the electronic device 100 corresponding to at least one of the above events by using the vibrating unit 170. The state identification module 161 controls the vibrating unit 170 to generate a vibration having a predetermined pattern. The state identification module 161 can collect a feedback signal corresponding to the vibration generated by the vibrating unit 170. The state identification module 161 can identify whether the collected feedback signal is similar to a specific feedback signal stored in the pattern DB 151. The state identification module 161 provides an analysis result of disposition state of the electronic device 100 for the input control module 163.

According to various embodiments of the present disclosure, the state identification module 161 can perform state identification of the electronic device 100 corresponding to at least one of the above events by using the sensor 180 and the vibrating unit 170. If an event is generated, the state identification module 161 operates the sensor 180. For example, the state identification module 161 can use a proximity sensor and an illumination sensor. The state identification module 161 can analyze the disposition state through the vibrating unit 170 if the approach measure and the intensity of the illumination are greater or less than predetermined values. Alternatively, the state identification module 161 can utilize an acceleration sensor according to the approach measure and the intensity of the illumination. Based on speed change information provided by the acceleration sensor, the state identification module 161 can identify whether the electronic device 100 is moving. Further, if the electronic device 100 is identified to be moving, the state identification module 161 can analyze the disposition state of the electronic device 100 through the vibrating unit 170.

The input control module 163 controls an input-enabled state and an input-disabled state of an input device according to information transmitted by the state identification module 161. For example, the input control module 163 can perform an input malfunction protection function if the electronic device is identified to be disposed in a pocket according to the analysis result of the disposition state provided by the state identification module 161. Namely, the input control module 163 can set the input device to an input-disabled state. If the analysis result of the disposition state provided by the state identification module 161 is a handheld state, the input control module 163 can set the input device to an input-enabled state.

According to settings of the input control module 163, at least one input device can be set to an input-enabled state or input-disabled state. For example, the input control module 163 can set only the side keys of the input unit 120 to the input-disabled state if the input-disabled state is requested according to the analysis result of the disposition state. According to various embodiments of the present disclosure, the input control module 163 can set a touch panel included in the display unit 140 to an input-disabled state and the input unit 120 to an input-enabled state if the input-disabled state is requested. According to various embodiments of the present disclosure, input control module 163 can set only the home key to the input-enabled state and other input devices to the input-disabled state. If an input signal is generated from an input device set to the input-enabled state, the input control module 163 can release the input-disabled state and set the remaining input devices to the input-enabled state.

According to various embodiments of the present disclosure, the electronic device 100 prevents the generation of a malfunction by setting an input device to an input-disabled state when the electronic device 100 is disposed in a specific location, and supports a convenient operation of the electronic device by setting the input device to an input-enabled state when the location is changed or a user requires an operation of the electronic device 100. The input control module 163 can set all of the input devices to an input-enabled state or an input-disabled state, and provide various input state controls by setting a portion of the input devices to the input-enabled state or the input-disabled state as described above. In particular, the input control module 163 can more intuitively process an input malfunction protection and a release of the input-disabled state by setting input devices, having a low possibility of being pressed while moving, in a state of being disposed in a specific location to an input-enabled state, and by setting the remaining input devices to an input-disabled state.

If an event is generated, the function processing module 165 can control execution of a function according to the event. For example, if a communication connection request is received, the function processing module 165 can control the processing of a display screen and an alarm according to the generation of the communication connection request. According to various embodiments of the present disclosure, the function processing module 165 controls the display unit 140 to output a message and alarm the reception of the message if the message is received. If an input signal is generated from an input device in an input-enabled state, the function processing module 165 controls function processing according to the generated input signal. For example, the function processing module 165 can control to form a communication channel by accepting a communication connection request according to the generation of the input signal. The function processing module 165 controls the display unit 140 to output a message signaling the reception of the message if an input signal is generated.

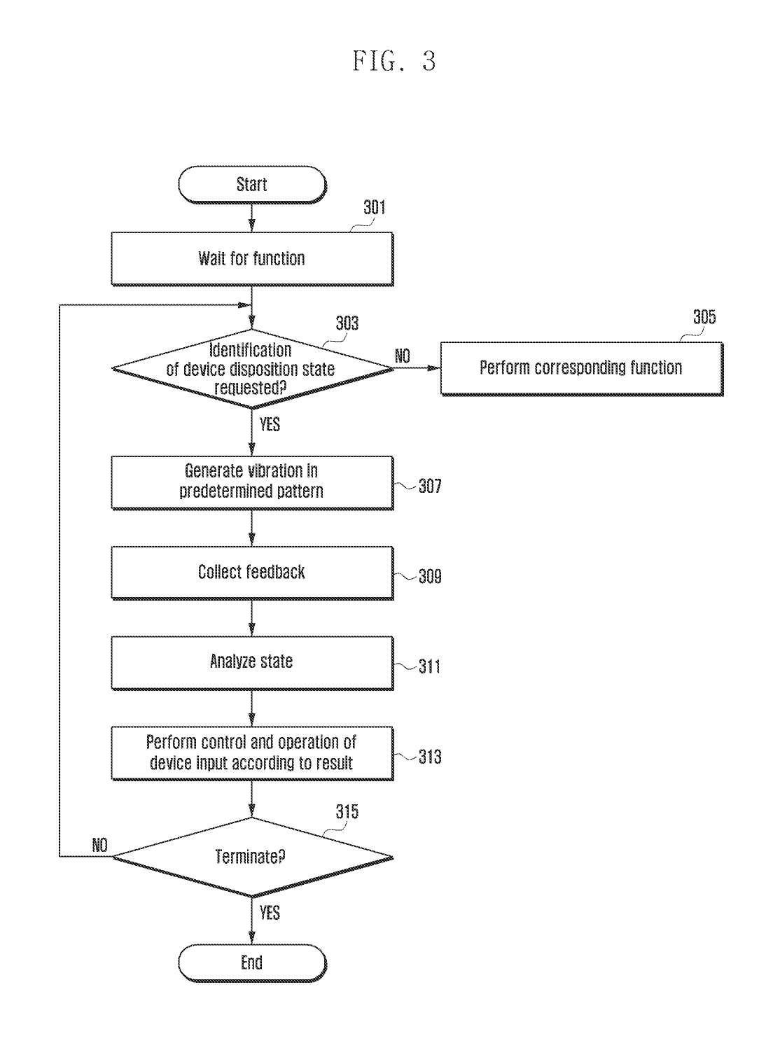

FIG. 3 is a flow chart illustrating a method for controlling an input state according to an embodiment of the present disclosure.

Referring to FIGS. 1 and 3, the control unit 160 controls to wait for a function at operation 301. The control unit 160 controls to maintain a sleep state in the function waiting operation or controls to maintain a previous operation state such as a music play state or a waiting screen output state.

If a specific event is generated, the control unit 160 identifies whether the generated event is a request for identifying a device disposition state at operation 303. The event requesting for identifying a device disposition state may be one of the specific events described before. If the event is not an event requesting for identifying a device disposition, the control unit 160 branches off to operation 305.

At operation 305, the control unit 160 controls to perform a function of the corresponding event. For example, the control unit 160 may control a music play function, a broadcasting reception function, or a web surfing function according to the types and characteristics of the event. Alternatively, if the event is for switching to a sleep mode, the control unit 160 controls to switch the electronic device 100 to the sleep mode. If an event requesting for identifying a device disposition state is generated at operation 303, the control unit 160 branches off to operation 307.

At operation 307, the control unit 160 controls to generate a vibration having a predetermined pattern. The control unit 160 transmits information of the predetermined pattern to the vibrating unit 170. The vibrating unit 170 generates a vibration according to the transmitted pattern information. Here, the predetermined pattern information may be information in a specific form predefined for device disposition state identification or predefined according to the characteristics of events. Vibration feedback signals by states corresponding to the predetermined pattern information may be pre-stored in the pattern DB 151. The vibration feedback signals by states may be collected and stored through experiments for the predetermined pattern information.

At operation 309, the control unit 160 controls to collect feedback signals for the currently generated vibration. The control unit 160 can activate a microphone MIC to collect the vibration feedback signal corresponding to the generation of vibration. The microphone MIC then transmits the current vibration feedback signal to the control unit 160.

At operation 311, the control unit 160 performs a status analysis. The operation of the status analysis may include a comparing operation, a detecting operation, and an identifying operation. For example, the control unit 160 can compare the current vibration feedback signals with vibration feedback signals stored in the pattern DB 151. Further, the control unit 160 can identify a pre-stored vibration feedback signal, or reference vibration feedback signal, having the most similar form to the current vibration feedback signal. If a pre-stored vibration feedback signal is identified, the control unit 160 can identify state information corresponding to the stored vibration feedback signal.

At operation 313, the control unit 160 performs an input control according to the status analysis result, and controls operations according to the generation of the input signal. For example, if the current state is identified to be a state where the electronic device is stored in a pocket, the control unit 160 can set at least one input device to an input-disabled state. The control unit 160 then disregards an event requesting for generating an input signal even though it is generated from the input device. According to various embodiments of the present disclosure, if the current state is identified to be a handheld state, the control unit 160 sets the input device to an input-enabled state. If input signals are generated from the input devices, the control unit 160 controls function processing according to the corresponding input signals. According to various embodiments of the present disclosure, if the stored state is changed to a handheld state, the control unit 160 can switch the input device from the input-disabled state to the input-enabled state. At this operation, the control unit 160 may perform state identification in a specific interval or in real time. For example if a communication connection request is received, the control unit 160 can perform the state identification periodically or in real time while signaling the reception of communication connection request.

At operation 315, the control unit 160 identifies whether an event for terminating operations is generated. If an event for terminating operations is generated, the control unit 160 controls to end the device input control of the electronic device 100. If an event for terminating operations is not generated, the control unit 100 branches off to operation 303 and controls to repeat the foregoing operations.

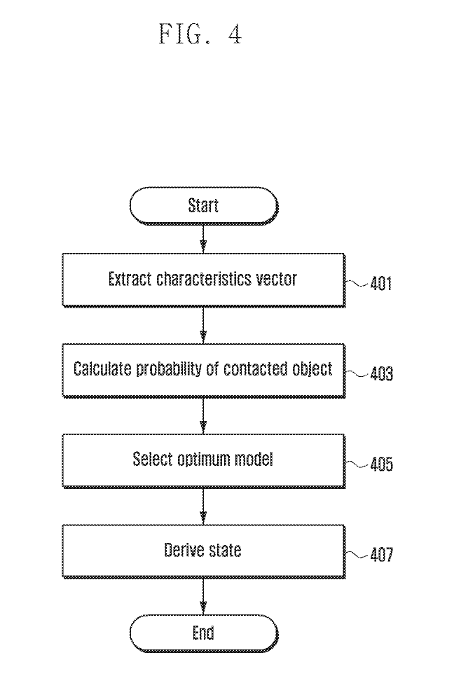

FIG. 4 is a flow chart illustrating a method of state analysis according to an embodiment of the present disclosure.

Referring to FIGS. 1 and 4, the state analysis operation described by operation 311 may include a characteristics vector extracting operation, a probability calculating operation, a model selecting operation, and a state deriving operation.

At operation 401, if the current vibration feedback signal is collected, the control unit 160 extracts a characteristics vector from the current vibration feedback signal. The control unit 160 simplifies information by filtering the current vibration feedback signal collected by the microphone MIC. The control unit 160 extracts characteristics from the simplified information and extracts a specific vector by arranging the extracted characteristics with a predefined rule.

At operation 403, the control unit 160 calculates a probability for a contacted object based on the extracted characteristics vector. At this operation, the control unit 160 compares the characteristics vector with a vibration feedback signal stored in the pattern DB 151. The vibration feedback signals in the pattern DB 151 may also be stored as characteristics vector values of vibration feedback signals by each state. The control unit 160 compares the characteristics vector of the current vibration feedback signal with the vibration feedback signals by states. The control unit 160 can identify a vibration feedback signal which has the most similar characteristics vector to the current characteristics vector. For example, if the electronic device 100 contacts an object having an elasticity like a human body, a feedback signal generated corresponding to a vibration having a predetermined pattern can be distinguished. According to various embodiments of the present disclosure, a feedback signal can be distinguished where the feedback signal is generated corresponding to a vibration having a predetermined pattern which is set under the condition of the electronic device 100 being laid on a hard desk. According to various embodiments of the present disclosure, a feedback signal collected according to a vibration having a predetermined pattern which is set by storing the electronic device 100 in a top pocket can also be distinguished. The control unit 160 can control to identify a device state by experimentally collecting vibration feedback signals by each state and comparing them with the current vibration feedback signal.

At operation 405, the control unit 160 selects a vibration feedback signal having the greatest value of probability as an optimum model. At operation 407, the control unit 160 performs a state deriving operation according to the vibration feedback signal corresponding to the optimum model.

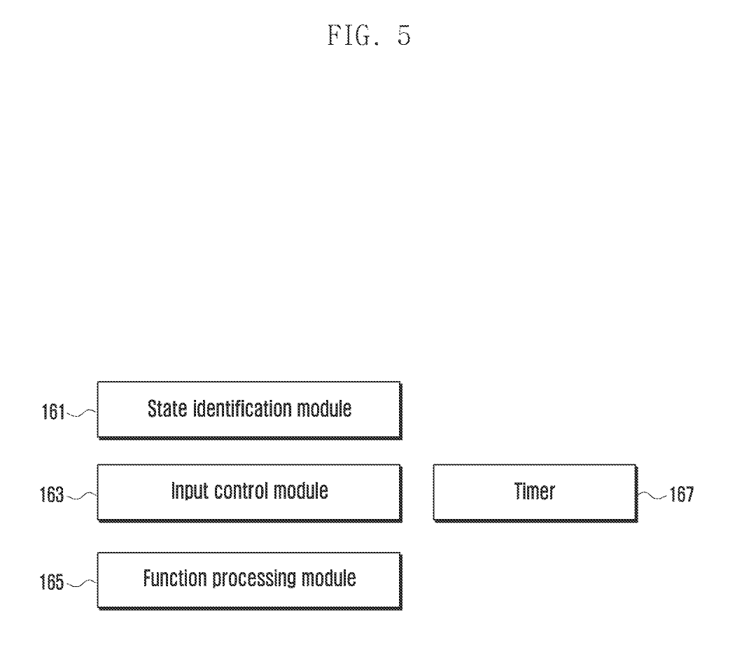

FIG. 5 is a block diagram illustrating modules for controlling an input state according to another embodiment of the present disclosure. The input state control modules can be included in the configuration of control unit 160 in the electronic device illustrated in FIG. 1.

Referring to FIG. 5, the modules for an input state control may include a state identification module 161, an input control module 163, a function processing module 165, and a timer 167. The modules for an input state control described in FIG. 5 include the state identification module 161, the input control module 163, and the function processing module 165 in FIG. 3, and additionally the timer 167. The input state modules in FIG. 5 perform a function of operating the timer 167 in addition to the functions of the operating modules in FIG. 3.

The state identification module 161 identifies a state of the electronic device 100. The state identification module 161 controls to generate a vibration having a predetermined pattern and to collect current vibration feedback signals corresponding to the vibration as described above. The state identification module 161 performs state identification by comparing the collected current vibration feedback signal with vibration feedback signals stored in the storage unit 150. The state identification module 161 controls the timer 167 if the current state is identified to be an input-disabled state. The state identification module 161 may control not to drive the timer 167 if the current state is identified to be an input-enabled state. The state identification module 161 transmits state information of the input-enabled state or the input-disabled state to the input control module 163. Here, for the input-enabled state or the input-disabled state, the state identification module 161 may transmit to the input control module 163 information notifying that the electronic device 100 is stored in a pocket or information notifying that the electronic device is handheld.

The input control module 163 may set at least one input device to an input-disabled state or an input-enabled state according to the state information transmitted to the state identification module 161. For example, the input control module 163 sets at least one input device to the input-disabled state if state information indicating the input-disabled state is received from the state identification module 161. If a change of an information input state is received from the state identification module 161 before the timer 167 is expired, the input control module 163 switches the input device from the input-disabled state to the input-enabled state. After the timer 167 is expired, the input control module 163 can set the input device to an input-enabled state.

The function processing module 165 controls function processing according an input signal generated by the input device if the input device is in the input-enabled state under the control of the input control module 163. The function processing module 165 can process function processing or alarming according to predefined schedule information if the input device is in the input-disabled state.

The timer 167 is driven for a predetermined time and informs the input control module 163 if the predetermined time is elapsed. The time set to the timer 167 can be adjusted according to a function applied to the input state control. For example, if a communication connection request is received, the timer 167 can set the time for maintaining the reception of the communication connection request as an expiration time. According to various embodiments of the present disclosure, if a message is received, the timer 167 can set a time for maintaining a popup message or a predetermined time as the expiration time.

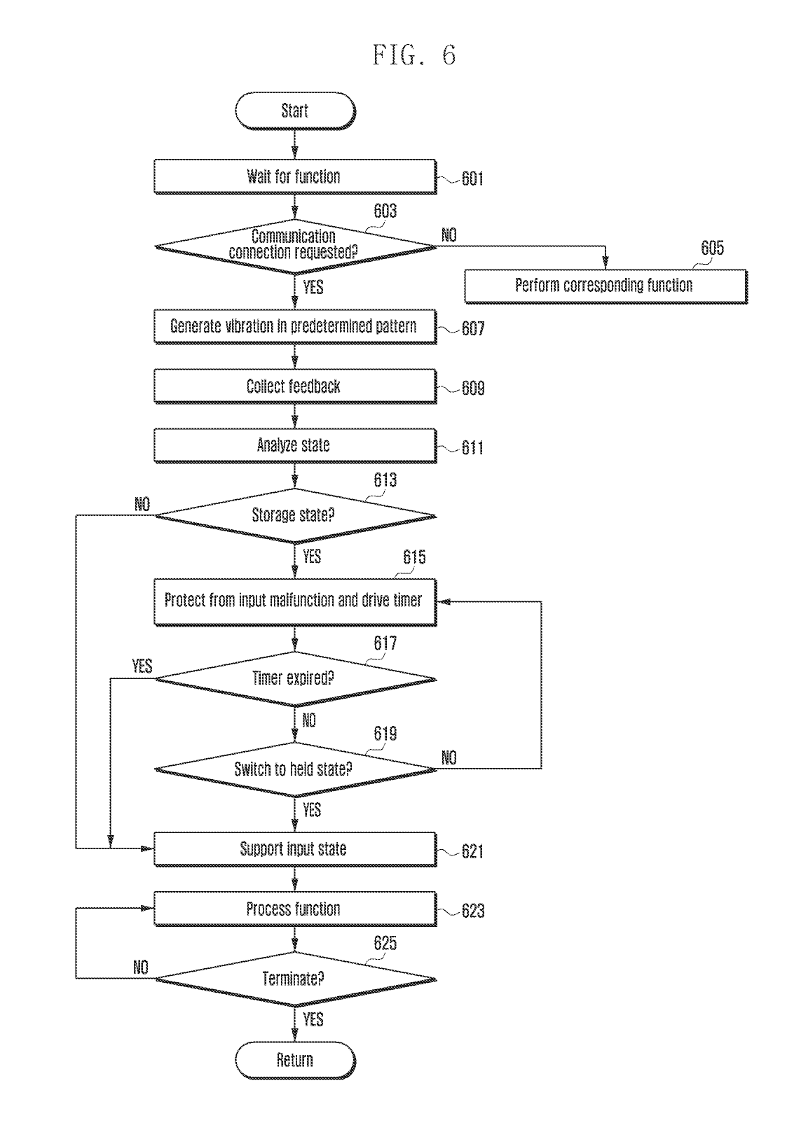

FIG. 6 is a flow chart illustrating a method for controlling an input state according to an embodiment of the present disclosure.

Referring to FIG. 6, the control unit 160 is initially in a function waiting state at operation 601. The function waiting state may be various states such as a sleep state, a waiting screen output state, a menu screen output state, and a display turned-off state with music playing in a background.

At operation 603, if an event is generated, the control unit 160 identifies whether the event is for receiving a communication connection request. Here, the reception of a communication connection request can be replaced by the reception of a message. Further, the reception of a communication connection request can be replaced by the generation of at least one of the previously described specific events. Hereafter, a procedure of receiving a communication connection request is described according to an embodiment of the present disclosure.

If the event is not for receiving a communication connection request, the control unit 160 controls to perform a function of the corresponding event at operation 605. For example, the control unit 160 may control to connect to a specific web server, perform a gallery function, or execute a game App.

If an event corresponding to reception of communication connection request is generated at operation 603, the control unit 160 controls to generate a vibration having a predetermined pattern at operation 607. Subsequently, the control unit 160 collects a current vibration feedback signal corresponding to the generated vibration at operation 609. The control unit 160 analyzes a device state based on the collected current vibration feedback signal at operation 611. The operation of analyzing a device state can be performed through the specific vector application method described in FIG. 4.

The control unit 160 identifies whether the electronic device 100 is in a storage state at operation 613. Here, the storage state may be a state where the electronic device 100 is disposed in a pocket of trousers or top clothing, or in a bag. According to various embodiments of the present disclosure, the storage state may be changed to a handheld state. The control unit 160 identifies whether the electronic device 100 is in a non-handheld state according to the state analysis at operation 613.

Each state may be different, and each state can be identified by comparing a current vibration feedback signal with a vibration feedback signal stored in the pattern DB 151 as described above. If the electronic device 100 is in a storage state, the control unit 160 can perform an input malfunction protecting function and drive the timer 167 at operation 615. The control unit 160 can support the input malfunction protecting function by setting at least one input device to an input-disabled state.

The control unit 160 identifies whether the timer 167 is expired at operation 617. Before the timer 167 is expired, the control unit 160 identifies whether the electronic device 100 has changed to a handheld state at operation 619. If there is no change to the handheld state before the timer 167 is expired, the control unit 160 branches off to operation 615 and performs the input malfunction protecting function and maintaining the drive state of the timer 167. The identification of a handheld state can be performed by operating the sensor 180. The control unit 160 can identify whether the environment of the electronic device 100 has changed by using at least one of an acceleration sensor and a proximity sensor. For example, the control unit 160 can identify whether the electronic device 100 has been picked up according to a cumulative signal analysis of the acceleration sensor. The control unit 160 can identify whether the electronic device 100 has contacted with a specific object or displaced from the object according to a signal analysis of the proximity sensor. If the electronic device is displaced from the specific object and moved more than a predetermined distance, the control unit 160 identifies that as a change to the handheld state.

The control unit can support the input-enabled state at operation 621 if the electronic device is not in a storage state at operation 613, if the time is expired at operation 617, or if the handheld state is changed. The control unit 160 can collect input signals generated by at least one of the input unit 120 and the display unit 140 having an input function. The control unit 160 performs function processing according to the collected input signals at operation 623. For example, the control unit 160 can form a communication channel with another electronic device if an input signal accepting a communication connection is generated.

Subsequently, the control unit 160 identifies whether an event for terminating operations is generated at operation 625. If the event for terminating operations is not generated, the control unit 160 can perform the function processing of operation 623. If the event for terminating operations is generated, the control unit 160 finishes the functions of the electronic device 100. For example, the control unit 160 can disconnect communication and return to the function waiting state of operation 610.

According to various embodiments of the present disclosure, a method for controlling an input state and an electronic device supporting the same enables that the current state of the electronic device can be more correctly identified through an analysis of the generation of vibration and feedback signals. If the correct state analysis is provided, various embodiments of the present disclosure can support to set at least one input device to an input-disabled state in order to prevent an input malfunction. Further, various embodiments of the present disclosure can support to set the input device to an input-enabled state if a state change is generated or a user input is identified to be acceptable. Various embodiments of the present disclosure can minimize a malfunction of input signals and support more intuitive operations of the electronic device through a correct state analysis and an operation control.

In the meantime, the aforementioned device can further include various add-on modules according to a device design. Namely, if the device is a communication device, the device can further include components not listed above such as an interface for data transmission in a wired or wireless communication system, an internet communication module for performing an internet function through an internet network, and a digital broadcasting module for receiving and playing a digital broadcasting. The components having such a configuration varies according to the convergence of digital equipment, and thus all the components cannot be listed here. However, components compatible with the components described above may be additionally included in the device. Further, the device of the present disclosure can exclude a component from the configuration or replace a component with another component according to the device design. These modifications will be apparent to those of ordinary skill in the art.

According to various embodiments of the present disclosure, the generation of an input signal undesired by a user can be minimized.

According to various embodiments of the present disclosure, a proper input state can be supported according to a disposition state of an electronic device.

According to various embodiments of the present disclosure, an unnecessary operation can be restrained and power consumption can be reduced by providing an input-enabled state only when a user requires an input operation.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for controlling an input state, the method comprising:
receiving a specific event generation;
generating a vibration having a predetermined pattern according to the specific event generation;
collecting a current vibration feedback signal according to the vibration;
comparing the current vibration feedback signal with a reference vibration feedback signal; and
controlling to set the input state of at least one input device to one of an input-disabled state and an input-enabled state according to a device disposition state corresponding to the current vibration feedback signal.

2. The method of claim 1, wherein the receiving a specific event generation comprises at least one of:
receiving a communication connection request event;
receiving a message event;
receiving a music play completion event;
receiving an alarm event of a scheduled appointment;
receiving a download completion event;
receiving a physical force event indicating a physical force applied to the input unit corresponding to a button press requesting a signal generation; and
receiving a touch input event requesting for an activation of the input device.

3. The method of claim 1, wherein the comparing the current vibration feedback signal with a reference vibration feedback signal comprises:
comparing a specific vector of the current vibration feedback signal with a specific vector of the reference vibration feedback signal.

4. The method of claim 1, wherein the controlling to set the input state of at least one input device comprises at least one of:
identifying whether the device disposition state is a stored state; and
identifying whether the device disposition state is a handheld state.

5. The method of claim 1, wherein the controlling to set the input state of at least one input device comprises;
controlling to set the input state of the input device to an input-enabled state if the device disposition state is a handheld state; and
controlling to set the input state of the input device to an input-disabled state if the device disposition state is a non-handheld state.

6. The method of claim 1, further comprising:
driving a timer if the device disposition state is a non-handheld state,
wherein the controlling to set the input state of the at least one input device further comprises:
controlling to set the input state of the input device to the input-enabled state if the timer is expired.

7. The method of claim 1, further comprising:
switching a non-handheld state to a handheld state,
wherein the controlling to set the input state of at least one input device further comprises:
switching the input device from the input-disabled state to the input-enabled state.

8. The method of claim 1, wherein the controlling to set the input state of at least one input device to the input-disabled state comprises:
setting a display device operating as a touch input device to the input-disabled state; and
setting the input device operating with a button press to the input-enabled state.

9. The method of claim 1, wherein the controlling to set the input state of at least one input device to the input-disabled state comprises:
setting the input device operating with a button press so that only a subset of buttons are enabled to input.

10. The method of claim 9, wherein the controlling to set the input state of at least one input device further comprises:
switching the input device to the input-enabled state if one of the subset of buttons enabled to input is pressed.

11. An electronic device for controlling an input state, the electronic device comprising:
a vibrator configured to generate a vibration having a predetermined pattern according to a generation of a specific event;
a control unit configured to collect a current vibration feedback signal corresponding to the vibration, to compare the current vibration feedback signal with a reference vibration feedback signal, and controlling to set the input state of at least one input device to one of an input-disabled state and an input-enabled state according to a device disposition state corresponding to the current vibration feedback signal; and
an input device configured to have one of an input-enabled state and an input-disabled state according to the control of the control unit.

12. The electronic device of claim 11, wherein the specific event comprises at least one of a communication connection request event, a message event, a music play completion event, an alarm event of a scheduled appointment, a download completion event, a physical force event indicating a physical force applied to the input unit corresponding to a button press requesting a signal generation, and a touch input event requesting for an activation of the input device.

13. The electronic device of claim 11, wherein the control unit identifies a reference vibration feedback signal similar to the current vibration feedback signal by comparing a specific vector of the current vibration feedback signal with a specific vector of the reference vibration feedback signal.

14. The electronic device of claim 11, wherein the control unit identifies whether the device disposition state is a stored state in a specific location or a handheld state through the comparison of the vibration feedback signals.

15. The electronic device of claim 11, wherein the control unit controls to set the input state of the input device to the input-enabled state if the device disposition state is a handheld state, and to the input-disabled state if the device disposition state is a non-handheld state.

16. The electronic device of claim 11, further comprising:
a timer configured to operate when the device disposition state is a non-handheld state,
wherein the control unit sets the input device to the input-enabled state when the timer is expired.

17. The electronic device of claim 11, wherein the control unit switches the input device from the input-disabled state to the input-enabled state when the device disposition state changes from a non-handheld state to a handheld state.

18. The electronic device of claim 11, wherein the control unit sets a display unit operating as a touch input device to the input-disabled state and the input device operating with a button press to the input-enabled state when controlling to set the input state of at least one input device to the input-disabled state.

19. The electronic device of claim 11, wherein the control unit controls to set the input state of a only a subset of buttons of the input device operating with a button press to the input-enabled state when controlling to set the input state of at least one the input device to the input-disabled state.

20. The electronic device of claim 19, wherein the control unit switches the input device to the input-enabled state if one of the subset of the buttons enabled to input is pressed.
